(19) United States
(12) Patent Application Publication
(10) Pub. No.: US 2003/0152702 A1
(43) Pub. Date: Aug. 14, 2003

(54) Method of forming a silica layer for optical waveguide

(75) Inventors: Min Jae Jung, Seoul (KR); Young Soo Han, Seoul (KR); Jong Moo Lee, Seoul (KR); Jae Eun Lee, Seoul (KR); Young Ho Choe, Kyonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/322,645

(22) Filed: Dec. 19, 2002

(30) Foreign Application Priority Data
Dec. 21, 2001 (KR) P2001-82569

(51) Int. Cl. C08J 7/06

(52) U.S. Cl. 427/255.28; 427/509; 427/163.2

(57) ABSTRACT

Disclosed is a method of forming a silica layer for an optical waveguide. The present invention includes the steps of preparing a chamber having a magnetic coil, a gas supply unit, and a support and injecting a reactant gas in the chamber to deposit the silica layer on a substrate mounted on the support by high density plasma chemical vapor deposition. The present invention provides the high deposition ratio of the silica layer since the ionization of the reactant gas proceeds fast due to the high density plasma induced by the magnetic coil. Moreover, the sputtering process by the inert gas and the silica layer depositing process are simultaneously carried out to provide the silica layer with a high deposition ratio and high density, whereby additional annealing is unnecessary as well as the process can be carried out at a low temperature to fabricate various silica-polymer mixed waveguide.

This application claims the benefit of the Korean Application No. P2001-82569 filed on Dec. 21, 2001, which is hereby incorporated by reference.

### BACKGROUND OF THE INVENTION

1. Field of the Invention

The present invention relates to a method of forming a silica layer for an optical waveguide.

2. Background of the Related Art

Generally, a silica waveguide in an optical device is made of the same material of an optical fiber, has an excellent optical characteristic of an optical loss below 0.01 dB/m, is very stable against environmental variations such as temperature, humidity, and the like, and can be manufactured by a general electronic device manufacturing process to enable mass production and low product cost. Moreover, since the silica waveguide has a guided mode similar to that of the optical fiber to reduce a connecting loss to the optical fiber, whereby great efforts have been made to research and develop the silica waveguide.

Various methods used in a semiconductor process such CVD (chemical vapor deposition), sputtering, sol-gel deposition, FHD (flam hydrolysis deposition), and the like are used for depositing silica.

Since a silica layer including stacked layers of a under-cladding layer (˜10 μm), a core layer (˜7 μm), and an over-cladding layer (˜15 μm) is deposited 20˜30 μm thick to use for an optical integrated circuit, a deposition ratio is an important factor for selecting equipments. Hence, FHD or CVD (especially, PECVD) is generally used for depositing silica for waveguide.

Polymer is spotlighted to replace silica, enables to fabricate a waveguide by a simple process, has large thermo-optic and electro-optic coefficients, has an easily adjustable composite ratio to control its properties, and has a large index contrast. Hence, the polymer enables to fabricate various optical integrated circuits having excellent performances.

However, the polymer has a loss according to polarization due to birefringence, is thermally and physically vulnerable, and has a tendency to combine with moisture or oxygen to degrade. Hence, the polymer needs a hermetic packaging.

FHD is a method developed on the basis of VAD (vapor phase axial deposition) used for fabricating an optical fiber by Kawachi et. al of NTT, Japan in the early 1980's. The FHD includes the steps of burning hydrogen (H₂) and oxygen (O₂) to provide flames and carrying out hydrolysis by putting a gas such as SiCl₄, GeCl₄, or the like in the flames to form 10˜100 nm micro-soot of SiO₂ on a silicon substrate having a melting point of 1,400° C. In order to form a silica film having an excellent transmittance and transparent homogeneity of high density, the micro-soot deposited on the silicon substrate needs densification at high temperature over 1,350° C.

The FHD has a very fast reposition ratio of 0.5˜1 μm, and is known as efficient for fabricating a silica waveguide several-tens μm thick. Yet, a thickness uniformity (5%) of the deposited silica layer by FHD is inferior to that (2˜3%) by CVD. Since the FHD is greatly affected by a subtle change of the process, a product yield is reduced for mass production. Besides, the low reproduction of equipments and the difficulty of an over-cladding process degrade the product yield severely.

Compared to the FHD, CVD is a general method used in fabricating silicon electronic devices. The CVD enables to prepare an excellent silica layer having a thickness uniformity of 2˜3% superior to that of the FHD. Yet, the CVD has a very slow reposition ratio of 10˜20 nm/min in general, thereby being hardly used. Instead, PECVD (plasma enhanced CVD) having a reposition ratio of 200˜300 nm/min is frequently used.

Recently, many efforts are made to research and develop a silica layer having an excellent reposition ratio as well as an excellent film characteristic using HDP-CVD (high density plasma density CVD) in PECVDs.

A silica layer deposited by the previous PECVD contains hydrogen massively due to silane (SiH₄) gas as a process gas. Hence, annealing, which is necessary for eliminating the hydrogen, is carried out for several hours at about 1,100° C. after the deposition of the silica layer. Besides, the FHD needs consolidation or annealing as a subsequent process at a temperature of at least 1,000° C.

However, the polymer layer is generally formed by spin-coating and has weak thermal stability, thereby failing to be accompanied by the high temperature process for fabricating the waveguide. And, HDP-CVD equipments include general CVD equipment and a special device enabling to increase a plasma density.

The previous silica layer deposited by CVD requires annealing, while the polymer layer deposited by spin-coating needs no annealing. Hence, it is impossible for the prior technology to combine the forming method of the silica layer with the forming method of the polymer layer. And, it is impossible to fabricate various waveguides including silica and polymer together.

Consequently, since the silica waveguide and the polymer waveguide have advantages and disadvantages, if a mixed waveguide making use of the advantages of the two materials is fabricated, an integration degree of the related art optical device can be greatly improved. Besides, a device having various functions, which cannot be implemented by the related art, can be fabricated.

### SUMMARY OF THE INVENTION

Accordingly, the present invention is directed to a method of forming a silica layer for an optical waveguide that substantially obviates one or more problems due to limitations and disadvantages of the related art.

An object of the present invention is to provide a method of forming a polymer-including silica layer for an optical waveguide.

Another object of the present invention is to provide a method of forming a silica layer for an optical waveguide enabling to fabricate a highly integrated optical device.

In order to achieve the above objects, the present invention forms the silica layer at a low temperature by HDP-CVD. Therefore, the present invention enables to fabricate a mixed waveguide having silica and polymer mixed with each other.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of forming a silica layer for an optical waveguide according to the present invention includes the steps of preparing a chamber having a magnetic coil, a gas supply unit, and a support and injecting a reactant gas in the chamber to deposit the silica layer on a substrate mounted on the support by high density plasma chemical vapor deposition.

Preferably, the high density plasma chemical vapor deposition is selected from the group consisting of ICP CVD and TCP CVD.

Preferably, the optical waveguide is fabricated on the substrate by mixing silica and polymer with each other.

More preferably, the polymer is formed by spin-coating.

Preferably, when the silica layer is deposited by the TCP CVD, a distance between the substrate and the magnetic coil is equal to or less than 5 cm.

Preferably, the silica layer is formed on the substrate using SiH₄ and O₂ as the reactant gas.

More preferably, the SiH₄ is preferentially deposited.

More preferably, the SiH₄ and an inert gas are injected in a gas injection ring or the SiH₄ diluted by the inert gas is injected in the gas injection ring.

More preferably, the inert gas is selected from the group consisting of He, Ar, N₂, and N₂O.

More preferably, an injection inlet of the gas injection ring has an inclined angle.

More preferably, the injection ring is supplied with the inert gas having an amount 0.5˜3 times larger than that of the SiH₄.

Preferably, the chamber maintains has a pressure of 5˜100 mTorr.

Preferably, the method further includes a step of carrying out plasma treatment by supplying O₂ or N₂O before the reactant gas is injected.

Preferably, the substrate is supplied with a RF bias of 100˜500W.

Preferably, the silica layer is deposited at 100˜200° C.

The silica layer in the waveguide is deposited by HDP-CVD, and preferably, by ICP-CVD or TCP-CVD. Even if SiH₄ is used, the high density plasma induced by the magnetic coil makes the ionization of the reactive gas proceed fast. Hence, the reposition ratio of the silica layer is increased. Since sputtering is carried out by the inert gas simultaneously when the deposition of the silica layer begins to form the silica layer of high density, the present invention requires no additional annealing process. Besides, since the above process can be processed at the low temperature, the damage of the polymer caused by the annealing process of the silica layer can be prevented even if the polymer-mixed waveguide is fabricated.

Moreover, the RF bias is applied to the substrate, thereby enabling to improve the thickness uniformity of the silica layer. Since the oxygen plasma etching process is carried out, an adhesion between the substrate and the silica layer can be increased.

The above-fabricated silica-polymer mixed waveguide enables to control refraction indexes of the respective layers (core layer, over-cladding layer, under-cladding layer) precisely as well as has a large index contrast, thereby enabling to overcome the size limitation by small index contrast which is the disadvantage of the silica waveguide. Therefore, the present invention enables to fabricate a highly integrated optical device.

And, since the mixed waveguide has the large thermo-optic effects, the present invention enables to fabricate a device having characteristics more excellent than those of the thermo-optic switch including the silica waveguide only.

Besides, the mixed waveguide has the electro-optic effects, thereby enabling to fabricate an electro-optic switch which cannot be fabricated by using the silica waveguide only.

Therefore, the mixed waveguide prevents the degradation, which is the disadvantage of the polymer waveguide, due to moisture and oxygen, improves thermal and mechanical stability, elongates endurance of the polymer device, and reduces a packaging cost.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1C illustrate cross-sectional views of equipments of ECR (electron cyclone resonance) CVD, ICP (inductively coupled plasma) CVD, and TCP (transformer coupled plasma) CVD;

FIGS. 2A to 2I illustrate cross-sectional views of silica-polymer mixed optical waveguides according to various embodiments of the present invention;

FIG. 3 illustrates a cross-sectional view of a process of fabricating the silica-polymer mixed waveguide shown in FIG. 2A;

FIG. 4 illustrates a diagram of densities of Cl atoms and Cl2 molecules when a chlorine gas is injected in a chamber;

FIG. 5A and FIG. 5B illustrate a TCP equipment and a graph of a deposition ratio of silica according to a substrate position;

FIG. 6 illustrates a gas injection inlet disclosed in a reference patent (Korean patent laid-open publication No: 10-2000-0022193);

FIG. 7 illustrates a cross-sectional view of a layer formed on a gap-having substrate by a deposition process;

FIG. 8 illustrates a diagram of a sputtering yield according to an angle of an Ar ion incident on a target;

FIG. 9 illustrates a cross-sectional view of a layer formed on a gap-having substrate by sputtering and deposition processes; and

FIG. 10 illustrates a graph of a uniformity of a silica layer according to a RF bias power of a substrate.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

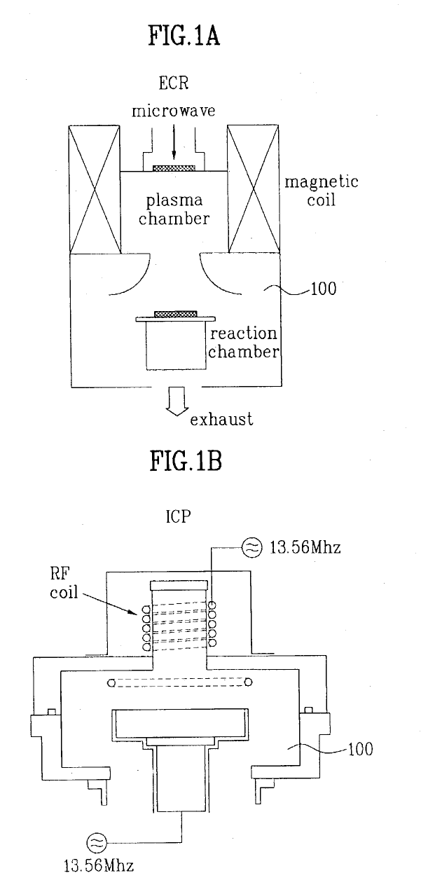

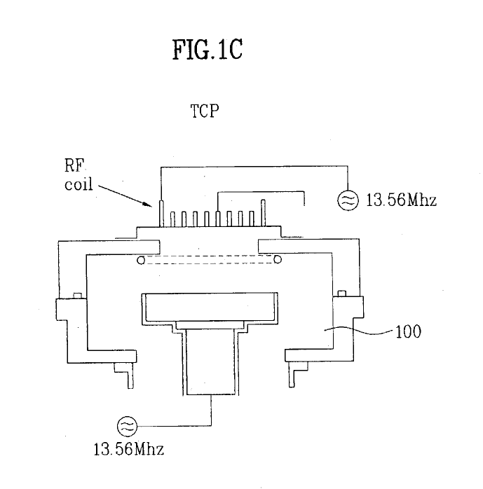

FIGS. 1A to 1C illustrate cross-sectional views of equipments of ECR (electron cyclone resonance) CVD, ICP (inductively coupled plasma) CVD, and TCP (transformer coupled plasma) CVD, respectively.

Referring to FIG. 1A, an ECR CVD equipment uses a magnetic coil. An ICP CVD equipment generates an induced magnetic field using a RF coil. And, a TCP CVD equipment as a sort of the ICP CVD equipments has a RF coil disposed in plane on a chamber. Currently, ICP type equipments including TCP types are widely used.

The ICP or TCP CVD equipment uses high density plasma, thereby enabling to carry out deposition at a temperature failing to degrade polymer. And, the ICP or TCP CVD equipment has a fast deposition ratio and enables to form a high density silica layer having less hydrogen content as well as small internal stress, thereby requiring no additional annealing. Hence, when the silica layer is deposited by ICP CVD, it is able to fabricate a waveguide having polymer and silica layers mixed with each other.

Meanwhile, HDP-CVD (high density plasma chemical vapor deposition) provides a high deposition ratio and excellent film characteristics. It is reported that the deposition ratio by HDP-CVD amounts to maximum 1 μm/min. And, Korean Patent Laid-open Publication No. 10-2000-0022193 discloses a shape and a location of a gas injection inlet for improving a deposition ratio. Besides, the layer deposited by HDP-CVD has very high density.

Even if a silane gas (SiH4) is used for depositing a silica layer by HDP-CVD, it is able to form a layer of very high density. Hence, the layer of very high density can be used as an optical device without additional annealing.

The silica waveguide has such advantages as compatibility with optical fibers, mature deposition technology, wide range of products, stable platform, and the like, thereby being widely used as a waveguide for an optical device.

Yet, the silica waveguide has some disadvantages such as limitation of size reduction due to maximum index contrast, OH— ion absorption, low thermo-optic sensitivity, and stress-induced birefringence, and the like.

On the other hand, the polymer waveguide has such disadvantages as loss according to polarization by birefringence, thermal and physical vulnerability, degradation caused by reaction with moisture or oxygen, and the like. Yet, the polymer waveguide has such advantages as controllable properties due to wide range of compositions, large index contrast, large thermo-optic effects, and the like. Hence, the silica waveguide fails to provide the advantages of the polymer waveguide.

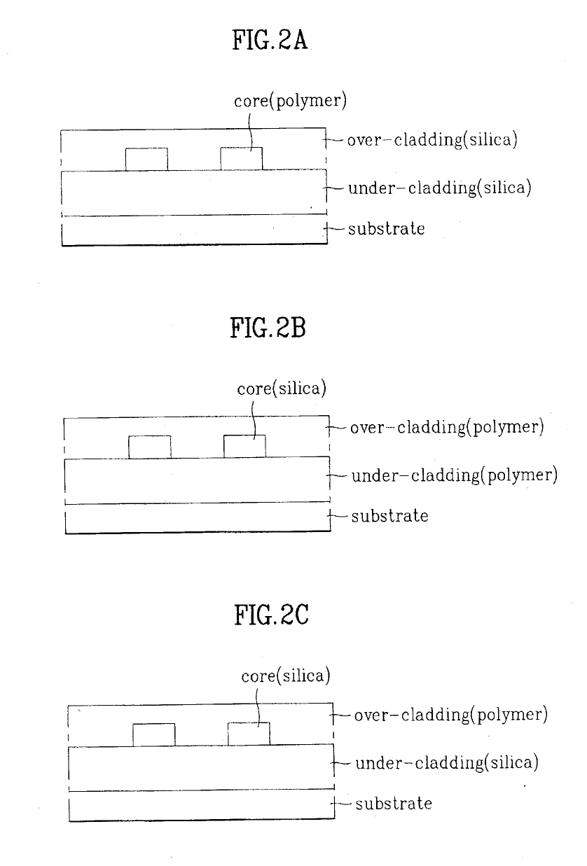

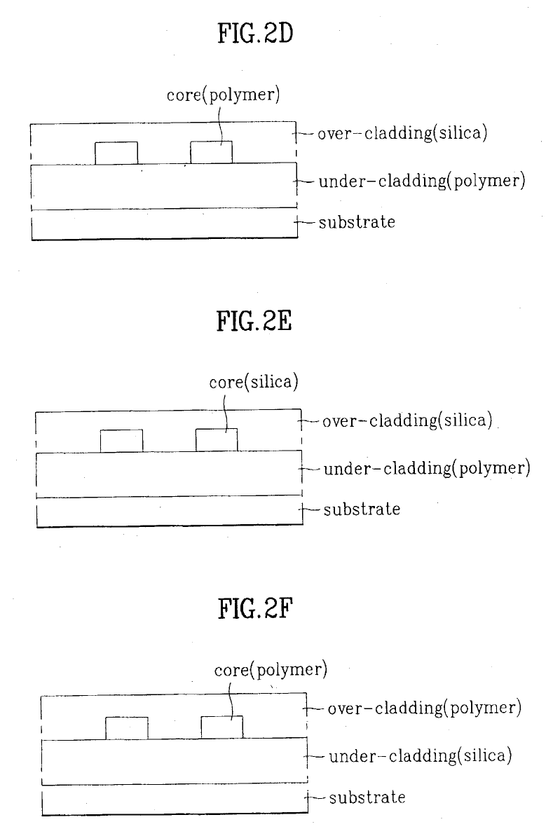

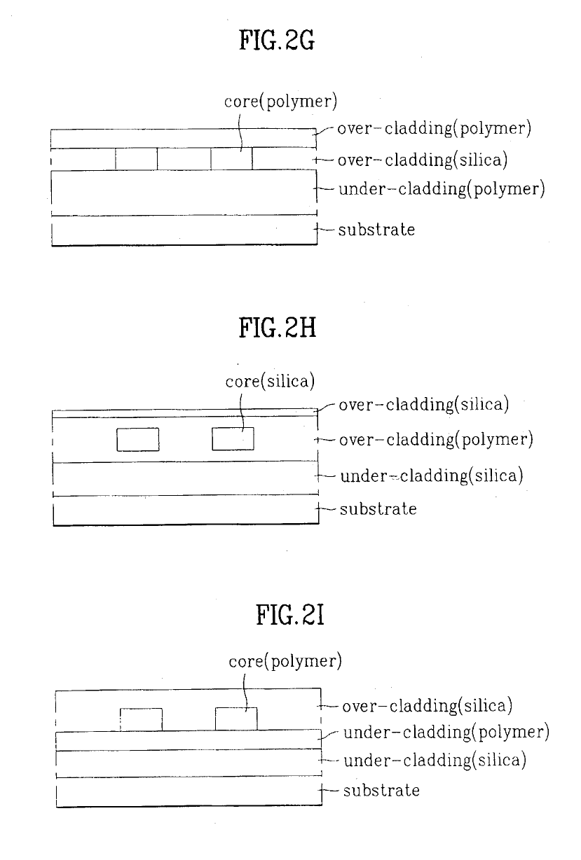

In case that the waveguide is fabricated by mixing silica and polymer with each other, as shown in FIGS. 2A to 2I, the advantages of the two materials can be provided while the disadvantages of the two materials can be compensated.

FIGS. 2A to 2I illustrate cross-sectional views of silica-polymer mixed optical waveguides according to various embodiments of the present invention.

For instance, when a waveguide having the structure shown in FIG. 2A is fabricated, a refraction index of a core layer is so freely controllable that it is able to fabricate a more highly integrated optical device. Moreover, since the core layer is formed of polymer, it is able to fabricate a thermo-optic switch of high performance or an electro-optic switch.

Even if a mixed waveguide shown in FIG. 2A, FIG. 2D, or FIG. 2I uses polymer as a core layer, it is able to protect a core layer against moisture and oxygen since an over-cladding is formed of silica. Moreover, it is able to reduce an expensive packaging cost since the degradation of the polymer can be prevented.

Meanwhile, a mixed waveguide shown in FIG. 2B, FIG. 2C, or FIG. 2H uses silica as a core layer, thereby having excellent compatibility with optical fibers and less thermo-mechanical stability. Besides, such a mixed waveguide enables to fabricate an optical integrated device operating by using easy variation of refraction index of the polymer cladding layer.

Hence, the most important fact of the waveguide fabricating process in FIGS. 2A to 2I is that a silica layer is deposited at a low temperature at which polymer fails to be broken down.

As mentioned in the foregoing description, FHD (flame hydrolysis deposition) fails to form a layer without a solidifying process at a temperature of at least 1,300° C., thereby failing to be applicable to a mixed waveguide process. And, a silica layer deposited by the previous PECVD (plasma enhanced chemical vapor deposition) undergoes an annealing process carried out at a high temperature of at least 1,000° C. to remove hydrogen ions (H⁺) inside as well as reduce an internal stress. Hence, the FHD or PECVD used in the related art fails to fabricate the silica-polymer mixed waveguide. Therefore, the present invention uses HDP-CVD (high density plasma CVD).

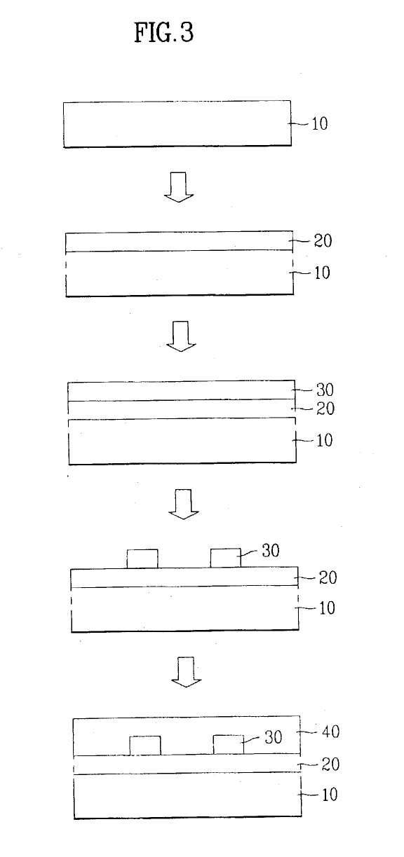

FIG. 3 illustrates a cross-sectional view of a process of fabricating the silica-polymer mixed waveguide shown in FIG. 2A.

Referring to FIG. 3, an under-cladding layer is formed by depositing silica 20 on a silicon substrate 10 by ICP or TCP CVD, and polymer 30 is then spin-coated on the silica 20 as a core layer.

The polymer 30 of the core layer is patterned by photolithography and plasma etch, and silica 40 as an over-cladding layer is deposited on the patterned polymer 30 by ICP or TCP CVD at a low temperature of 100˜200° C.

In order to gain a high silica deposition ratio, a sufficient gas amount and a pumping speed enabling to handle the gas are necessary. And, high power is applied thereto to increase dissociation and ionization ratios of the injected gas.

Moreover, when the HDP CVD equipment is used, the gas dissociation and ionization ratios onto the substrate are varied in accordance with the location of the substrate even if the same power is applied thereto.

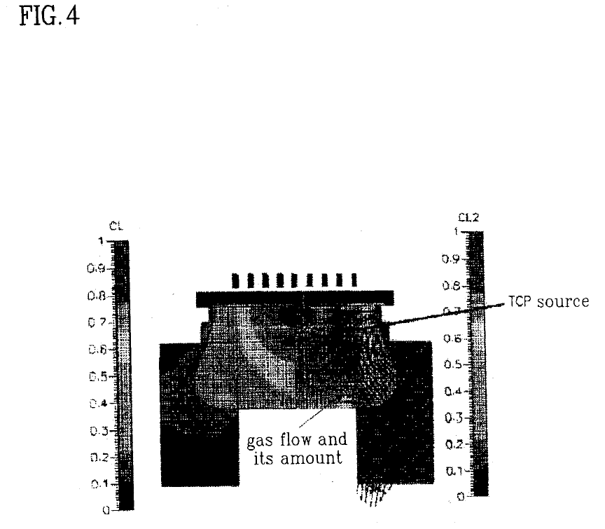

FIG. 4 illustrates a diagram of densities of Cl atoms and Cl2 molecules when a chlorine gas is injected in a chamber, in which shown is a simulation result of amounts of Cl and Cl₂ existing in a chamber when a Cl₂ gas is injected in a TCP chamber.

Referring to FIG. 4, dissociation of the gas occurs more actively in an upper portion of the chamber.

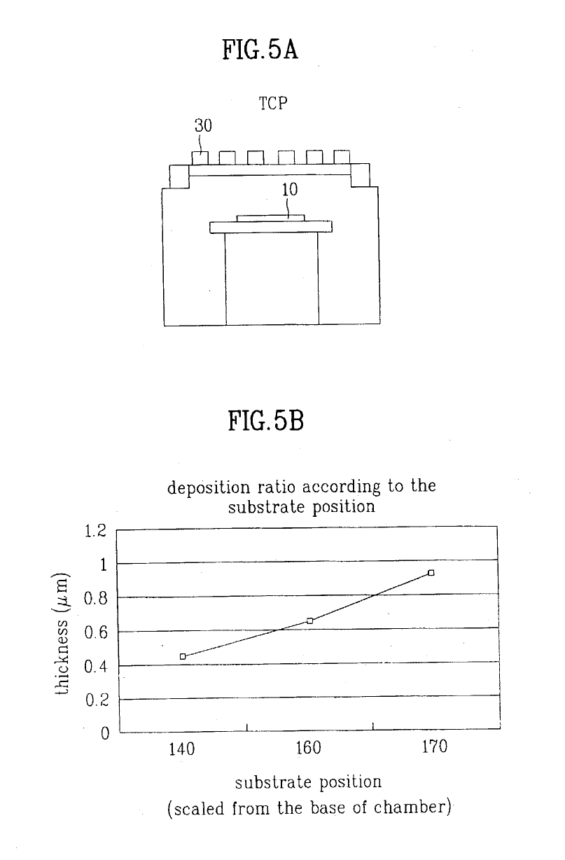

FIG. 5A and FIG. 5B illustrate a TCP equipment and a graph of a deposition ratio of silica according to a substrate position.

Referring to FIG. 5A and FIG. 5B, a deposition ratio according to the position of a substrate 10 increases as the position of the substrate 10 is lifted higher since dissociation of a gas becomes more active on depositing silica. Using such a characteristic, the position of the substrate 10 becomes in the vicinity within 5 cm of a RF coil 30 to deposit silica thereon in order to increase the deposition ratio.

Moreover, the deposition ratio can be increased by adjusting the gas amount and a gas injection ring. HDP-CVD uses a silane (SiH₄) gas and an oxygen (O₂) gas as reactant gases to deposit silica in general. These two gases reacts with each other spontaneously over a predetermined high pressure to explode. Generally, in order to prevent the explosion, the gas injection rings for respectively injecting the silane and oxygen gases are installed to separate from each other.

In case of the silane gas for the reaction, it is important for silane to be directed to the substrate 10 since most radicals (SiH3, SiH2, SiH, etc.) produced from the dissociation of silane have high adhesion coefficients.

Namely, it is important for the silicon containing gas to be concentrated on the substrate 10. In Korean Patent Laid-open publication No. 10-2000-0022193, a structure of a gas injection inlet is specially shaped or a gas exceeding a requisite amount is injected to bring about supersonic airflow at a gas injection ring exhaust.

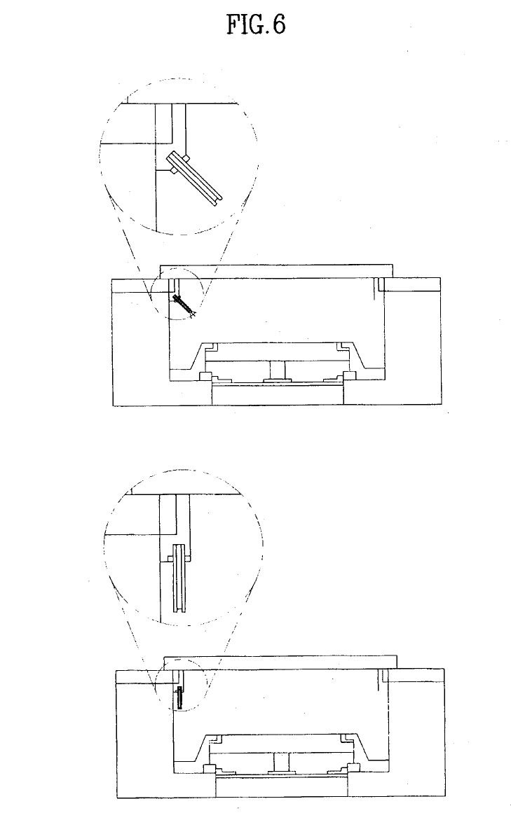

FIG. 6 illustrates a gas injection inlet disclosed in a reference patent (Korean patent laid-open publication No: 10-2000-0022193).

Referring to FIG. 6, an injection inlet has a shape of a gun barrel having a narrow front to accelerate the injection of the gas faster.

Moreover, an angle of the injection inlet is properly adjusted to send the silane gas on the substrate effectively.

Instead of injecting a surplus reactant gas, an inert gas (He, Ar, or N₂) as well as silane is injected in the gas injection ring (not shown in FIG. 5).

The inert gas having an amount 0.5˜3 times larger than that of the silane gas injected in a chamber 100 is injected in the same gas injection ring to accelerate the gas flow at the gas injection inlet of the injection ring, whereby the silicon-containing gas is concentrated on the substrate 10 to increase the deposition ratio.

Moreover, the injection of the inert gas (He, Ar, N₂, N₂O) brings about an sputtering effect during the silica deposition process to improve the planarity and the gap-filling characteristic of a deposited silica layer.

HDP having high density of plasma enables to deposit silica while maintaining low pressure to carry out at very high vacuum of 5 mTorr˜100 mTorr, whereby a mean free path of ions is elongated.

When a RF bias is applied to the substrate 10, the ions strongly become impacted on the substrate 10 without collision with other gas species. Hence, sputtering may occur while a layer is being deposited. Such a sputtering effect improves the planarity and gap-filling characteristic of the layer.

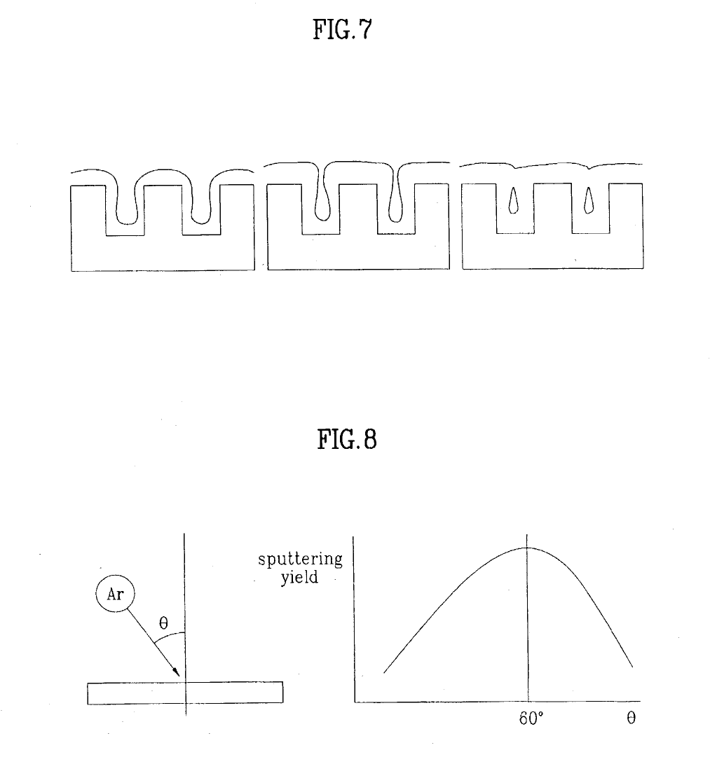

FIG. 7 illustrates a cross-sectional view of a layer formed on a gap-having substrate by a deposition process.

Referring to FIG. 7, a layer tends to be insufficiently accumulated on a space having a narrow gap, thereby failing to fill up the gap.

Yet, when a RF bias is applied to a substrate 10 at the high vacuum state, sputtering occurs while a layer is being deposited and a sputtering amount varies in accordance with a location of the layer.

FIG. 8 illustrates a diagram of a sputtering yield according to an angle of an Ar ion incident on a target.

Referring to FIG. 8, a sputtering amount varies according to an incident angle of Ar. The sputtering amount of Ar becomes maximum at the incident angle of about 60°.

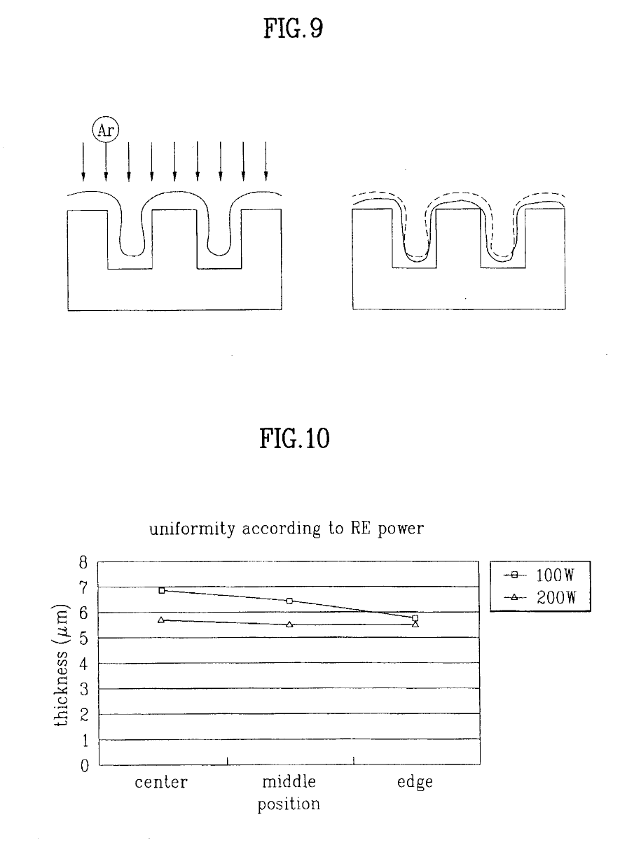

Namely, the sputtering, as shown in FIG. 9, occurs more at the portion forming 60° on the deposited layer which is being deposited, whereby the layer is deposited while the gap is always open.

When a silica layer 20 at least 10 μm thick is deposited by PECVD, a stress applied to the silica layer 20 is very large. Such a stress has influence on an adhesiveness between the substrate 10 and the silica layer 20. Hence, the present invention introduces O₂-plasma etch in a process of depositing the silica layer 20 to improve the adhesiveness between the substrate 10 and the silica layer 20. Namely, when O₂— or N₂O-plasma treatment is carried out by injecting an O₂ or N₂O gas after the silicon substrate 10 is loaded in the chamber 100 before injection of the reactant gases (SiH₄+O₂ or N₂O), it is able to remove particles or contaminants on the silicon substrate 10 as well as form a thin SiO₂ layer on the substrate 10. Therefore, the compatibility with the deposited silica layer 20 is improved to increase the adhesiveness to the substrate.

As mentioned in the foregoing description, in HDP CVD, the plasma density at the low pressure is so high to bring about the sputtering effect. Therefore, the present invention adjusts the RF power applied to the substrate 10 to improve the planarity and the gap-filling characteristic of the layer.

FIG. 10 illustrates a graph of a uniformity of a silica layer according to a RF bias power of a substrate.

Referring to FIG. 10, using the above-explained characteristics, a thick portion of the deposited silica layer 20 is preferentially etched more than a thin portion of the deposited silica layer 20.

Namely, the RF power applied to the substrate is adjusted to 100˜500W to control the sputtering amount, thereby enabling to deposit the silica layer having excellent thickness uniformity only.

Accordingly, the method of forming the silica layer for the optical waveguide using HDP CVD according to the present invention has the following effects or advantages.

First of all, when the silica layer is deposited, the present invention provides the high deposition ratio of the silica layer since the ionization of the reactant gas proceeds fast due to the high density plasma induced by the magnetic coil.

Moreover, the sputtering process by the inert gas and the silica layer depositing process are simultaneously carried out to provide the silica layer with a high deposition ratio and high density, whereby additional annealing is unnecessary as well as the process can be carried out at a low temperature.

Besides, the RF bias applied to the substrate is controlled to improve the thickness uniformity of the silica layer. Since the oxygen plasma etching process is carried out, the adhesion between the substrate and the silica layer can be increased.

The above-fabricated waveguide enables to control refraction indexes of the respective layers (core layer, over-cladding layer, under-cladding layer) precisely as well as enables a large index contrast, thereby enabling to overcome the size limitation by small index contrast which is the disadvantage of the silica waveguide. Therefore, the present invention enables to fabricate a highly integrated optical device.

It will be apparent to those skilled in the art that various modifications and variations can be made in the present invention. Thus, it is intended that the present invention covers the modifications and variations of this invention provided, they come within the scope of the appended claims and their equivalents.

What is claimed is:

1. A method of forming a silica layer for an optical waveguide, comprising the steps of:
preparing a chamber having a magnetic coil, a gas supply unit, and a support; and
injecting a reactant gas in the chamber to deposit the silica layer on a substrate mounted on the support by high density plasma chemical vapor deposition.

2. The method of claim 1, wherein the high density plasma chemical vapor deposition is selected from the group consisting of ICP CVD and TCP CVD.

3. The method of claim 1, wherein the optical waveguide is fabricated on the substrate by mixing silica and polymer with each other.

4. The method of claim 3, wherein the polymer is formed by spin-coating.

5. The method of claim 1, wherein, when the silica layer is deposited by the TCP CVD, a distance between the substrate and the magnetic coil is equal to or less than 5 cm.

6. The method of claim 1, wherein the silica layer is formed on the substrate using SiH₄ and O₂ as the reactant gas.

7. The method of claim 6, wherein the SiH₄ is preferentially deposited.

8. The method of claim 6, wherein the SiH₄ and an inert gas are injected in a gas injection ring or the SiH₄ diluted by the inert gas is injected in the gas injection ring.

9. The method of claim 8, wherein the inert gas is selected from the group consisting of He, Ar, N₂, and N₂O.

10. The method of claim 8, wherein an injection inlet of the gas injection ring has an inclined angle.

11. The method of claim 8, wherein the injection ring is supplied with the inert gas having an amount 0.5˜3 times larger than that of the SiH₄.

12. The method of claim 1, wherein the chamber maintains has a pressure of 5˜100 mTorr.

13. The method of claim 1, further comprising a step of carrying out plasma treatment by supplying O₂ or N₂O before the reactant gas is injected.

14. The method of claim 1, wherein the substrate is supplied with a RF bias of 100˜500W.

15. The method of claim 1, wherein the silica layer is deposited at 100˜200° C.
